(19) United States
(12) Patent Application Publication
(10) Pub. No.: US 2006/0062416 A1
(43) Pub. Date: Mar. 23, 2006

(54) Ear-cushion mechanism for safety helmets with hand-free cellular phone server

(76) Inventor: Shang-Hua Wu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/944,737

(22) Filed: Sep. 21, 2004

(51) Int. Cl. A42B 1/06; H04R 25/00

(52) U.S. Cl. 381/376; 381/370; 381/379; 2/209

(57) ABSTRACT

An ear-cushion mechanism for safety helmet with hand-free cellular phone server. Its main feature is a circular cushion on the ear-muffs of a safety helmet, with an indentation along the inner circumference of the cushion. An elastic net is attached to the inner circumference of the cushion near the bottom. Between the net and the bottom of the indentation is an accommodating space for the hand-free cellular phone server. Besides, on one side of the cushion there is a narrow channel that connects the accommodating space of the cushion with the outside. The hand-free cellular phone server that contains both a speaker and a microphone is put into the accommodating space of the cushion through the narrow channel and held by the elastic net.

### BACKGROUND OF THE INVENTION

1. Field of the Invention

The present invention relates to an ear-cushion mechanism for safety helmets with hand-free cellular phone server. Specifically it comprises a circular cushion on the ear-muffs of a safety helmet, with an indentation along the inner circumference of the cushion. An elastic net is attached to the inner circumference of the cushion near the bottom. Between the net and the bottom of the indentation is an accommodating space for the hand-free cellular phone server. Besides, on one side of the cushion there is a narrow channel that connects the accommodating space of the cushion with the outside. The hand-free cellular phone server that contains both a speaker and a microphone is put into the accommodating space of the cushion through the narrow channel and held by the elastic net. In this way, the mechanism serves the purpose of simple assembly, saving time, and easy maintenance.

2. Description of the Related Art

A common safety helmet with hand-free cellular phone server is disclosed in Utility Pat. No. 423,277 “Safety Helmet Mechanism Innovation”. For this kind of safety helmets, there is a long indentation on the inner side near the ears. A base is set in the indentation. This base contains a speaker and at the bottom of the base is a signal plug. This server has the function of answering the cell phone while wearing a safety helmet. Another common safety helmet is disclosed in Utility Pat. No. 366,166 “Hand-Free Cellular Phone Mechanism For Safety Helmets”. It relates to a safety helmet with an ear cover and orientation device. Inside the ear cover is an electronic parts box with a microphone. There is a hole on the orientation device and a slot on a plank. Furthermore, a screw is forced into the electronic parts box through the slot and the hole to fix the hand-free cellular phone mechanism inside the safety helmet. However, the two mechanisms mentioned above has the following drawbacks in design:
1. The base protruding from the indentation presses the motorcyclist's ears and causes discomfort.
2. The indentation or orientation device is fixed to the inner side of the safety helmet before the base and ear cover is forced into it. The result is that the base or ear cover tends to drop out of the safety helmet easily.
3. There are a large number of parts. The complicated assembly procedure increases the production cost.

The drawbacks in design mentioned above cause inconveniences in assembly and maintenance as well as an increase in production cost. In contract, the present invention is effective in design and grows out of much effort in research.

### SUMMARY OF THE INVENTION

The present invention aims to provide an ear-cushion mechanism with hand-free cellular phone server. Its assembly and maintenance are easier and faster. Besides, the production cost is reduced. The mechanism relates to a circular cushion on the ear-muffs of a safety helmet, with an indentation along the inner circumference of the cushion. An elastic net is attached to the inner circumference of the cushion near the bottom. Between this net and the bottom of the indentation is an accommodating space for the hand-free cellular phone server. Besides, on one side of the cushion there is a narrow channel that connects the accommodating space of the cushion with the outside. The hand-free cellular phone server that contains both a speaker and a microphone is put into the accommodating space of the cushion through the narrow channel and held by the elastic net.

### BRIEF DESCRIPTION OF THE DRAWINGS

FIG. 1 is an exploded view of the mechanism and a cross sectional view of the elastic net;

FIG. 2 is an exploded view of the present invention;

FIG. 3 is a cross sectional view of the assembly;

FIG. 4 is a view illustrating the assembly;

FIG. 5 is a view illustrating another coupling; and

FIG. 6 is a view illustrating the assembly of the mechanism in FIG. 5 and the safety helmet.

### DETAILED DESCRIPTION OF THE INVENTION

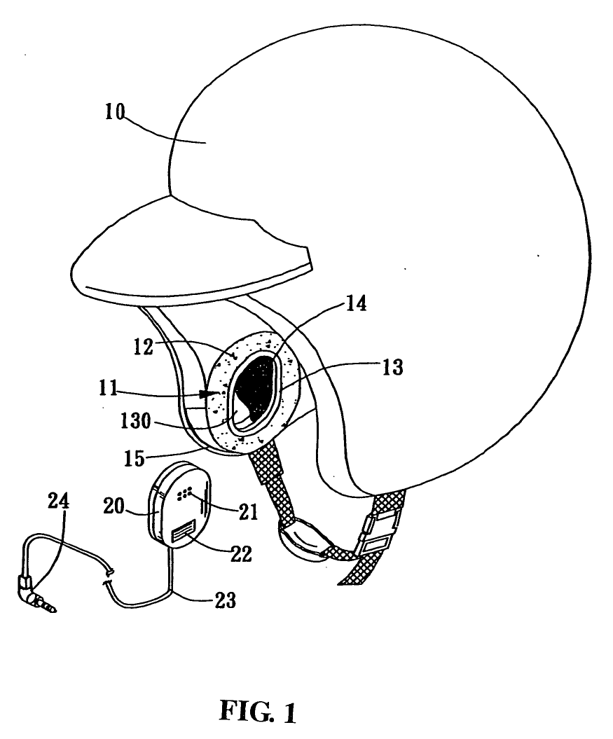

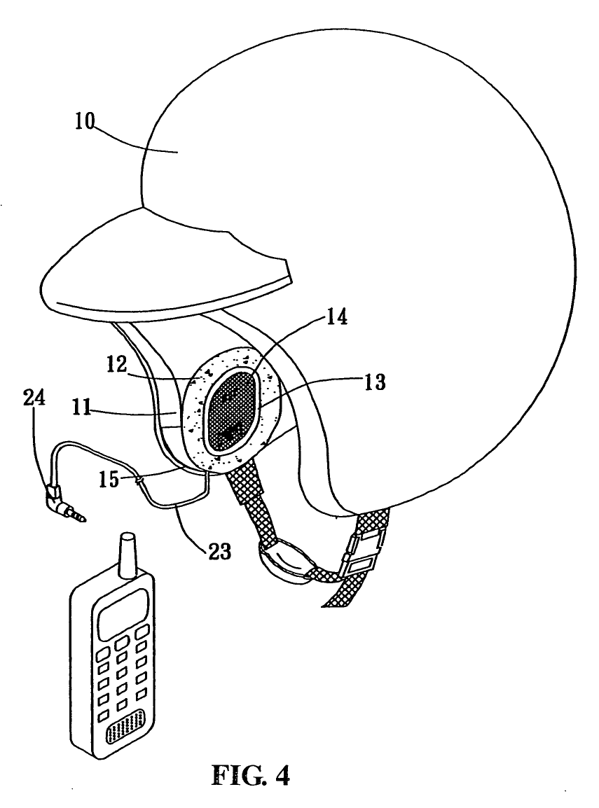

Referring to the drawings, and initially to FIGS. 1 to 5, the present invention comprises a circular cushion (12) on the ear-muffs (11) of a safety helmet (10), with an indentation (13) along the inner circumference of the cushion (12). An elastic net (14) is attached to the inner circumference of the cushion (12) near the bottom. Between this net (14) and the bottom of the indentation (13) is an accommodating space (130) for the hand-free cellular phone server (20). Besides, on one side of the cushion (12) there is a narrow channel (15) that connects the accommodating space (130) of the cushion (12) with the outside. The hand-free cellular phone server (20) that contains both a speaker (21) and a microphone (22) is put into the accommodating space (130) of the cushion (12) through the narrow channel (15) and held by the elastic net (14). In this way, the mechanism serves the purpose of simple assembling, saving time, and easy maintenance.

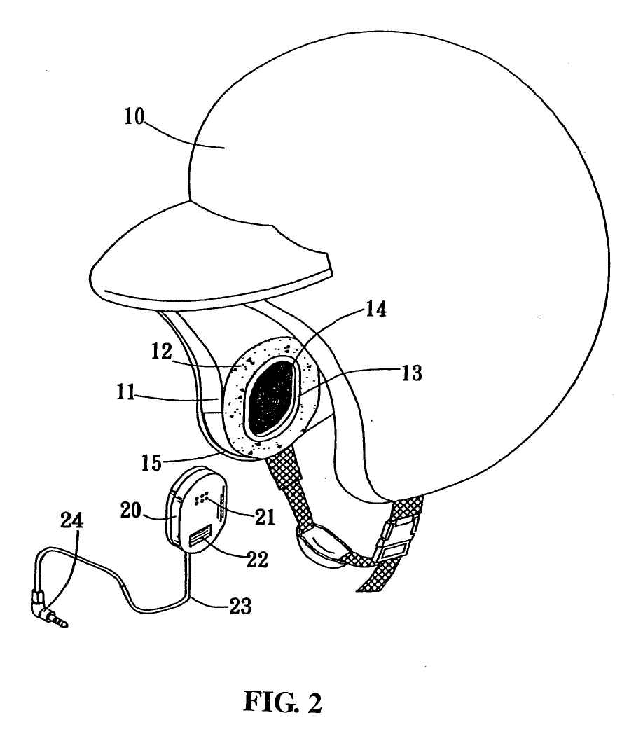

Besides, referring to the drawings in FIGS. 2-4, the narrow channel (15) of the cushion (12) has magic tapes (16) (160) on the opposite surfaces. The magic tapes serve to seal the narrow channel (15) after the server (20) is put into the accommodating space (130).

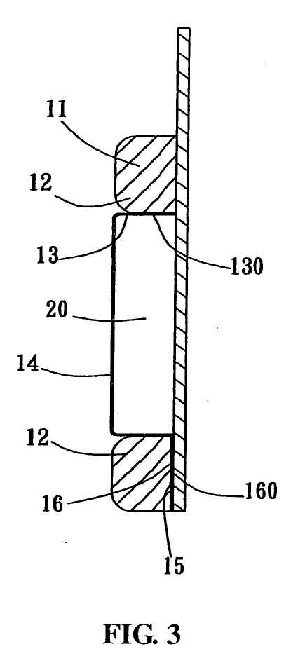

Please refer to the drawings in FIGS. 2 and 3. In assembling the present invention, first the server (20) is put into the accommodating space (130) through the narrow channel (15) of the cushion (12) and held by the elastic net (14). The elasticity of the net (14) fixes the server within the accommodating space (130). If the server (20) has a signal plug (23), the plug (23) can stretch outside of the narrow channel (15) a little bit. Then the magic tapes (16) (160) on the opposite surfaces can stick together to seal the narrow channel (15), leaving only a small passage for the signal plug (23) to stretch out of it. This is the way that the present invention is assembled.

Please refer to the drawings in FIGS. 2-4. In coupling the present invention, the safety helmet (10) is put on first. The motorcyclist's ears touch the indentation (13) of the cushion. The speaker (21) of the server (20) aims at the motorcyclist's ears. Because the safety helmet (10) has an elastic net (14) and circular cushion (12), the server (20) will not directly touch the motorcyclist's ears. When the cellular phone (50) rings, the motorcyclist can answer the phone through the safety helmet (10) without holding the cellular phone (50).

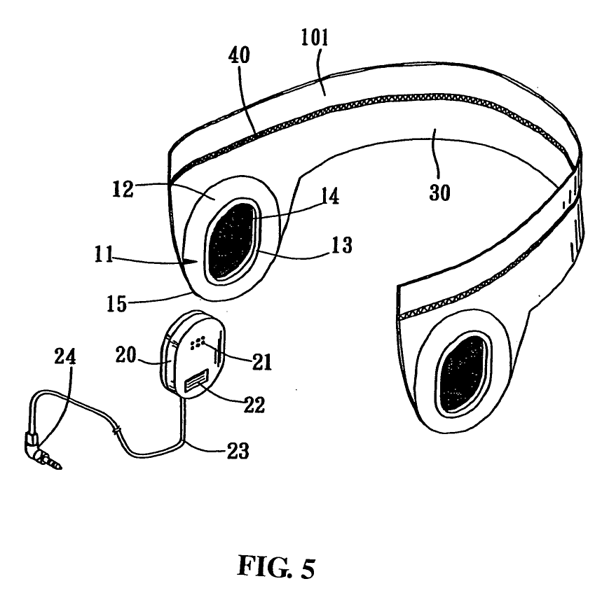

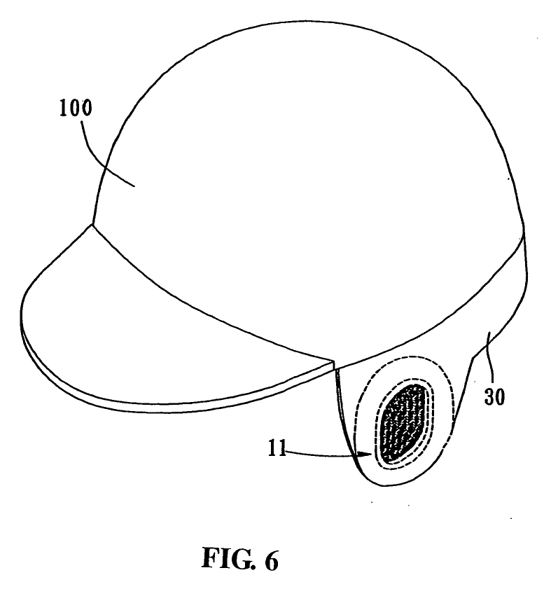

Please refer to the drawings in FIGS. 5-6, which relate to another coupling of the present invention. The circular cushion (12) on the ear-muffs (11) of the safety helmet (10) is fixed to the end of a connecting chip (30). This chip (30) has a zipper (40) along the edge at the top. The safety helmet (100) also has a zipper along the edge at the bottom (101). The connecting chip (30) can combine with the safety helmet (10) via the zipper (40). Thus the present invention is also applicable to half-cover safety helmet.

The design of the present invention mentioned above has the following advantages:
1. The present invention does not need to fix the indentation with screws. Instead, the server is installed directly via the narrow channel. Besides, the soft circular cushion and net at the ear-muffs of the safety helmet do not cause pressure or discomfort to motorcyclists.
2. By stalling the server directly via the narrow channel, the assembly and maintenance are easier and faster. Besides, the production and maintenance costs are greatly reduced.
3. The server can be firmly held in the accommodating space between the bottom of the indentation and the net. Thus the present invention is more effective than prior inventions. Besides, the parts are simplified, which can greatly reduce instances of malfunction.

To sum up, the present invention has the advantages of lower cost as well as faster and easier assembly or maintenance. This invention features novelty, innovation, and effectiveness, which conform to the requirements of Utility patent. Accordingly, this application is submitted.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

1. An ear-cushion mechanism for safety helmet with hand-free cellular phone server comprising:
an ear muff member for a helmet;
a cushion mounted to the ear muff member and having an inner circumference defining an accommodating space thereagainst, the cushion defining against the ear muff member a narrow channel communicating with the accommodating space of the cushion for passage into the accommodating space therethrough;
an elastic net being attached to the inner circumference of the cushion to extend over the accommodating space;
a hand-free cellular phone server having both a speaker and a microphone elastically captured in the accommodating space by the elastic net and the cushion; and
a lead wire with a first end for connecting to the hand-free cellular phone server and a second end extending from the accommodating space for connecting to a cellular phone.

2. The apparatus as claimed in claim 1, wherein the narrow channel of the cushion has magic tapes on opposite surfaces thereabout serving to seal the narrow channel.

3. The apparatus as claimed in claim 1 further comprising an attachment portion for detachably attaching the ear muff member to a helmet.

4. The apparatus as claimed in claim 3, comprising a pair of ear muff members joined by a connecting chip extending therebetween, the attachment portion being formed on the connecting chip.
